(19) United States
(12) Patent Application Publication
(10) Pub. No.: US 2026/0169650 A1
(43) Pub. Date: Jun. 18, 2026

(54) MEMORY INTERFACE CIRCUIT AND MEMORY CONTROL METHOD

(71) Applicant: Sigmastar Technology Ltd., Xiamen (CN)

(72) Inventors: Song Zhu, Xiamen (CN); Wei Sheng Du, Xiamen (CN); Yan Xiong Wu, Xiamen (CN)

(21) Appl. No.: 19/398,366

(22) Filed: Nov. 24, 2025

(30) Foreign Application Priority Data
Dec. 13, 2024 (CN) 202411844304.6

(51) Int. Cl. G06F 3/06

(52) U.S. Cl. CPC G06F 3/0655; G06F 3/0604; G06F 3/0673

(57) ABSTRACT

A memory interface circuit is applied to an electronic device that includes a computing circuit and a memory. The memory interface circuit is coupled to the computing circuit and the memory and includes a command storage circuit, a state machine, and a memory control circuit. The command storage circuit is configured to store at least one command. The state machine is coupled to the command storage circuit and is configured to manage a current mode of the memory. The memory control circuit is coupled to the state machine and is configured to switch the current mode of the memory. The memory control circuit controls the memory to periodically operate in a first mode and a second mode, and the memory does not process the at least one command in the first mode.

This application claims the benefit of China application Serial No. CN 202411844304.6, filed on Dec. 13, 2024, the subject matter of which is incorporated herein by reference.

### BACKGROUND OF THE INVENTION

### 1. Field of the Invention

The present invention generally relates to a memory, and more particularly, to a memory interface circuit and a memory control method.

### 2. Description of Related Art

The “suspend to RAM” (hereinafter referred to as STR) utilizes the self-refresh mode of a dynamic random access memory (DRAM) to reduce the power consumption of an electronic device. When the DRAM is operating in the self-refresh mode, the DRAM is in a dormant state and cannot be accessed. In contrast, when the DRAM is not operating in the self-refresh mode, the DRAM is in an idle state and can be accessed.

Due to the fact that in the STR state (i.e., the power-saving state), the functional circuits of the electronic device (e.g., the encoding/decoding circuit, the encryption/decryption circuit, etc.) cannot access the DRAM, the electronic device undergoes the following state switching procedures when entering and exiting the STR state to ensure that the electronic device does not encounter errors: the media switch (i.e., the system switches between the DRAM and the static random access memory (SRAM)), the suspension of the functional circuit(s), the suspension of the system, the resumption of the system, and the resumption of the functional circuit(s). However, the state switching procedures involve cumbersome switching steps, which are quite time-consuming, causing the electronic device to be unable to respond in a timely manner to the DRAM read requests from the time-sensitive functional circuit(s), thereby severely degrading the performance and user experience of the electronic device.

### SUMMARY OF THE INVENTION

In view of the issues of the prior art, an object of the present invention is to provide a memory interface circuit and a memory control method, so as to make an improvement to the prior art.

According to one aspect of the present invention, a memory interface circuit is provided. The memory interface circuit is applied to an electronic device that includes a computing circuit and a memory. The memory interface circuit is coupled to the computing circuit and the memory and includes a command storage circuit, a state machine, and a memory control circuit. The command storage circuit is used to store at least one command. The state machine is coupled to the command storage circuit and is used to manage a current mode of the memory. The memory control circuit is coupled to the state machine and is used to switch the current mode of the memory. The memory control circuit controls the memory to periodically operate in a first mode and a second mode, and the memory does not process the at least one command in the first mode.

According to another aspect of the present invention, a memory control method is provided. The memory control method applied to a memory interface circuit. The memory interface circuit stores at least one command and includes a first counter and a second counter. The first counter and the second counter generate a first count value and a second count value, respectively. The method includes the following steps: controlling, according to the first count value, a memory to exit a first mode and enter a second mode; and controlling, according to the second count value, the memory to exit the second mode and enter the first mode. In the second mode, the memory does not process the at least one command.

The technical means embodied in the embodiments of the present invention can solve at least one of the problems of the prior art. Therefore, compared to the prior art, the present invention can improve the performance and user experience of electronic device.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is the functional block diagram of an electronic device according to an embodiment of the present invention.

FIG. 2 is the functional block diagram of a state machine and a memory control circuit according to an embodiment of the present invention.

FIG. 3 is a schematic diagram of the memory state according to an embodiment of the present invention.

FIG. 4 is the flowchart of the memory control method according to an embodiment of the present invention.

FIG. 5 is the flowchart of the memory entering and exiting the self-refresh mode SR according to an embodiment of the present invention.

FIG. 6 is the schematic diagram of the memory state according to another embodiment of the present invention.

FIGS. 7A to 7B are flowcharts of the memory control method according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a memory interface circuit and a memory control method. On account of that some or all elements of the memory interface circuit could be known, the detail of such elements is omitted provided that such detail has little to do with the features of this disclosure, and that this omission nowhere dissatisfies the specification and enablement requirements. Some or all of the processes of the memory control method may be implemented by software and/or firmware and can be performed by the memory interface circuit or its equivalent. A person having ordinary skill in the art can choose components or steps equivalent to those described in this specification to carry out the present invention, which means that the scope of this invention is not limited to the embodiments in the specification.

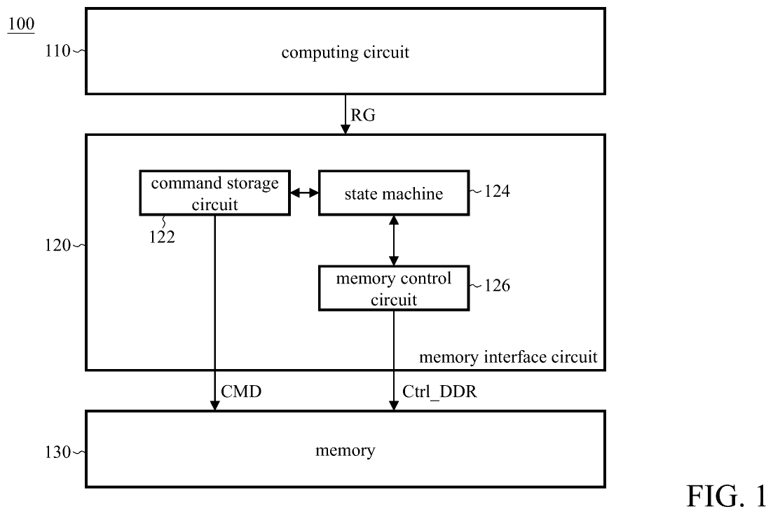

Reference is made to FIG. 1, which is a functional block diagram of the electronic device according to an embodiment of the present invention. The electronic device 100 includes a computing circuit 110, a memory interface circuit 120, and a memory 130, all of which are coupled to each other. The computing circuit 110 controls and accesses the memory 130 through the memory interface circuit 120. In some embodiments, the memory 130 may be a DRAM.

The computing circuit 110 may be a circuit or electronic component with program execution capability, such as a central processing unit (CPU), a microprocessor, a microcontroller unit, a digital signal processor (DSP), an application-specific integrated circuit (ASIC), or an equivalent circuit. The computing circuit 110 implements some functions of the electronic device 100 by executing the program code and/or program instructions stored in the memory 130.

The memory interface circuit 120 is used to control and access the memory 130 and includes the command storage circuit 122, the state machine 124, and the memory control circuit 126, all of which are coupled to each other. The command storage circuit 122 is used to store the command CMD. The command CMD may be generated by the computing circuit 110 or a functional circuit (not shown). The state machine 124 records, detects, and switches the state of the memory 130. When the state of the memory 130 needs to be switched, the state machine 124 controls the memory 130 through the memory control circuit 126 to switch the state of the memory 130. In some embodiments, the state machine 124 can be implemented by a logic circuit.

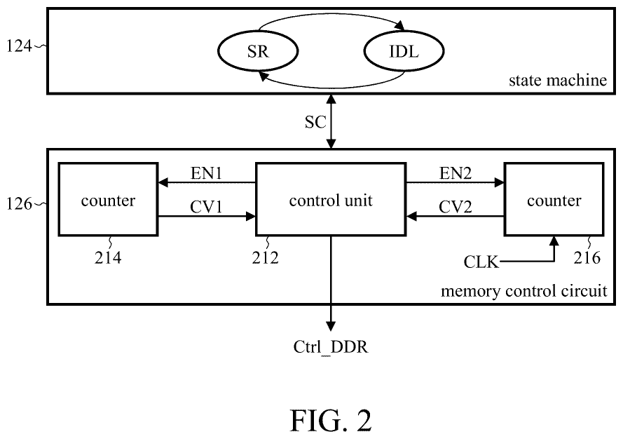

Reference is made to FIG. 2, which is a functional block diagram of the state machine 124 and the memory control circuit 126 according to an embodiment of the present invention. The state machine 124 manages the current mode of the memory 130: either the self-refresh mode SR or the idle mode IDL. The command storage circuit 122 sends a signal to the state machine 124 upon receiving the command CMD, and the state machine 124 determines whether the current state of the memory 130 can respond to the command CMD. When it is necessary to switch the state of the memory 130 (i.e., when the memory 130 is unable to respond to the command CMD), the state machine 124 notifies the memory control circuit 126 via the signal SC to switch the state of the memory 130. Subsequently, the memory control circuit 126 controls, through the control signal Ctrl_DDR, the memory 130 to switch its state (e.g., entering or exiting the STR state, also known as the self-refresh mode SR).

The memory control circuit 126 includes a control unit 212, a counter 214, and a counter 216, all of which are coupled to each other.

The control unit 212 uses the control signal EN1 to control the counter 214 to start counting and/or reset. The counter 214 counts the number of commands CMD processed by the memory 130 in the idle mode IDL. Each time the memory 130 processes a command CMD, the counter 214 increments the count value CV1 by one.

The control unit 212 uses the control signal EN2 to control the counter 216 to start counting and/or reset. The counter 216 counts according to the system clock CLK to generate the count value CV2. For example, every time the system clock CLK completes a cycle, the counter 216 increments the count value CV2 by one.

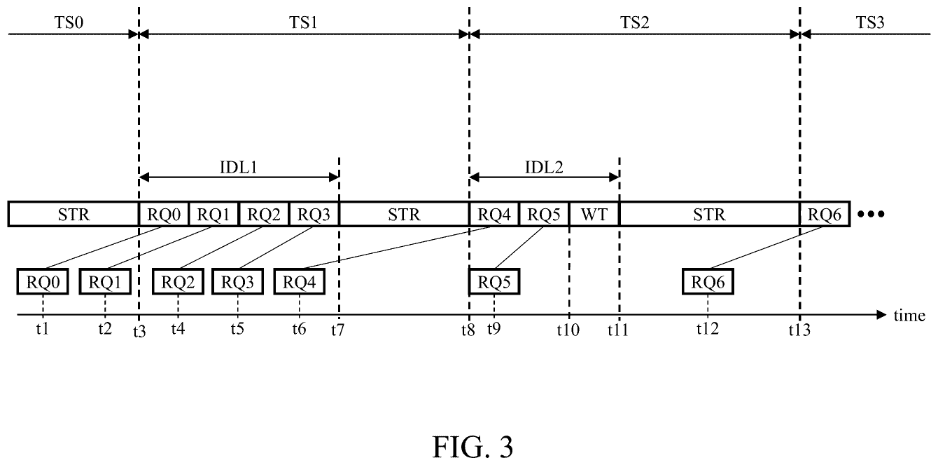

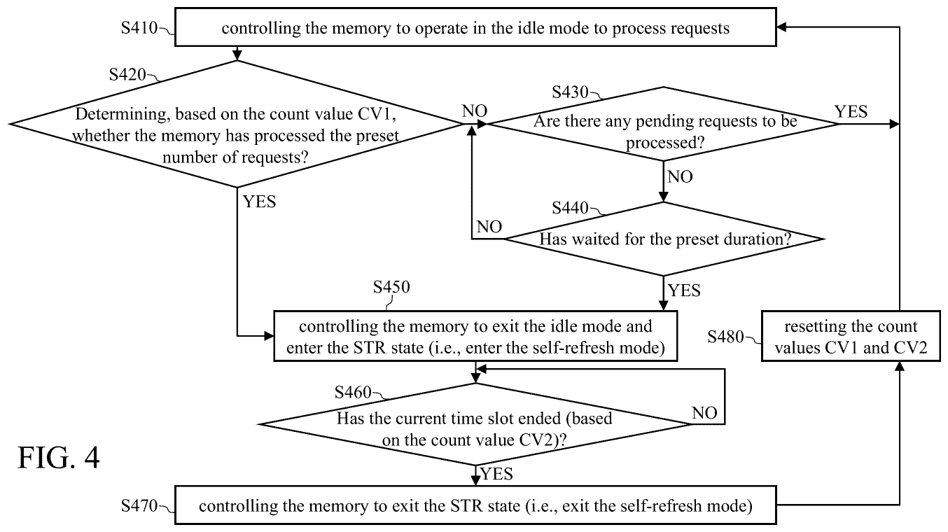

The control unit 212 controls the state of the memory 130 based on the count value CV1 and the count value CV2 and notifies the state machine 124 that the state of the memory 130 has switched. The operational details according to an embodiment of the present invention are discussed below with reference to FIG. 3 and FIG. 4. In the following discussion, “command” and “request” are equivalent.

Reference is made to FIG. 3, which is a schematic diagram of the memory state according to an embodiment of the present invention. The time slots TS0 to TS3 are consecutive time slots, and the length of the time slots is controlled by the control unit 212 based on the count value CV2. For example, when the count value CV2 equals the first preset value, the control unit 212 ends the current time slot, starts the next time slot, and resets the counter 216 (i.e., resets the count value CV2) through the control signal EN2. That is to say, the control unit 212 controls the memory 130 to perform periodic operations according to the time slots (i.e., according to the system clock CLK).

Reference is made to FIG. 4, which is a flowchart of the memory control method according to an embodiment of the present invention. The flow includes the following steps.

Step S410: When a time slot begins (which is substantially equivalent to the end of the previous time slot (when step S460 is YES), corresponding to the time point t3 and the time point t8 in FIG. 3), the control unit 212 uses the control signal Ctrl_DDR to control the memory 130 to operate in the idle mode IDL (e.g., the idle mode IDL1 or IDL2) to process requests. As shown in FIG. 3, in the idle mode IDL1 of the time slot TS1, the memory 130 processes the requests RQ0, RQ1, RQ2, and RQ3 generated at the time points t1, t2, t4, and t5, respectively, and, in the idle mode IDL2 of the time slot TS2, the memory 130 processes the requests RQ4 and RQ5 generated at the time points t6 and t9, respectively.

Step S420: The memory interface circuit 120 determines, based on the count value CV1, whether the memory 130 has processed the preset number of requests (the second preset value). In the example of FIG. 3, the preset number is four. When the memory 130 completes processing the preset number of requests in the idle mode IDL (the result of step S420 is YES, that is, when the count value CV1 equals the second preset value, for example, at the time point t7), the control unit 212 uses the control signal Ctrl_DDR to control the memory 130 to exit the idle mode IDL and enter the STR state (i.e., operate in the self-refresh mode SR) (step S450), thereby saving power. If the result of step S420 is NO, then the flow proceeds to step S430.

It should be noted that, in the example of FIG. 3, although the request RQ4 is generated in the time slot TS1, since the idle mode IDL (IDL1) of the time slot TS1 has already been utilized to process the four requests RQ0 to RQ3, the memory 130 must wait until the next time slot (i.e., the time slot TS2) to process the request RQ4.

Step S430: The memory interface circuit 120 determines whether there are any pending requests to be processed. If YES, then the flow returns to step S410 to process the request; otherwise, the flow proceeds to step S440.

Step S440: The memory interface circuit 120 determines whether it has waited for the preset duration WT. In the example of FIG. 3, the memory 130 exits the STR state and enters the idle mode IDL2 at the time point t8, and then processes the request RQ4 and the request RQ5 in the idle mode IDL2. Next, since there are no pending requests to be processed (step S430 is NO), the control unit 212 begins to count the preset duration WT based on the count value CV2 (e.g., between the time point t10 and the time point t11 in FIG. 3). When the memory interface circuit 120 does not receive any new request in the idle mode IDL for the preset duration WT (that is, when the memory 130 does not process any requests in the idle mode IDL2 for the preset duration WT, for example, at the time point t11), the control unit 212 controls the memory 130 to exit the idle mode IDL2 early and enter the STR state to further save power. “Early” refers to the situation where, even though the number of requests processed by the memory 130 has not reached the preset number (the second preset value), the control unit 212 still controls the memory 130 to exit the idle mode IDL2 and enter the STR state (step S450). In other words, in the embodiment of FIG. 3, the duration of the idle mode IDL1 (t7-t3) is greater than or equal to the duration of the idle mode IDL2 (t11-t8), that is, the duration of the STR state in the time slot TS1 (t8-t7) is less than or equal to the duration of the STR state in the time slot TS2 (t13-t11).

Step S450: The memory interface circuit 120 controls the memory 130 to exit the idle mode IDL and enter the STR state (i.e., enter the self-refresh mode SR).

Step S460: The memory interface circuit 120 determines whether the current time slot has ended based on the count value CV2. If YES, then the flow proceeds to step S470; otherwise, the memory interface circuit 120 continues waiting for the current time slot to end.

Step S470: The memory interface circuit 120 controls the memory 130 to exit the STR state (i.e., exit the self-refresh mode SR).

Step S480: The control unit 212 resets the count value CV1 and the count value CV2, then the flow returns to step S410 to enter the idle mode IDL in the next time slot. That is to say, the control unit 212 periodically resets the count value CV1 and the count value CV2.

It should be noted that, in the example of FIG. 3, the time slot TS2 ends at the time point t13, and the request RQ6 generated at the time point t12 is processed in the time slot TS3.

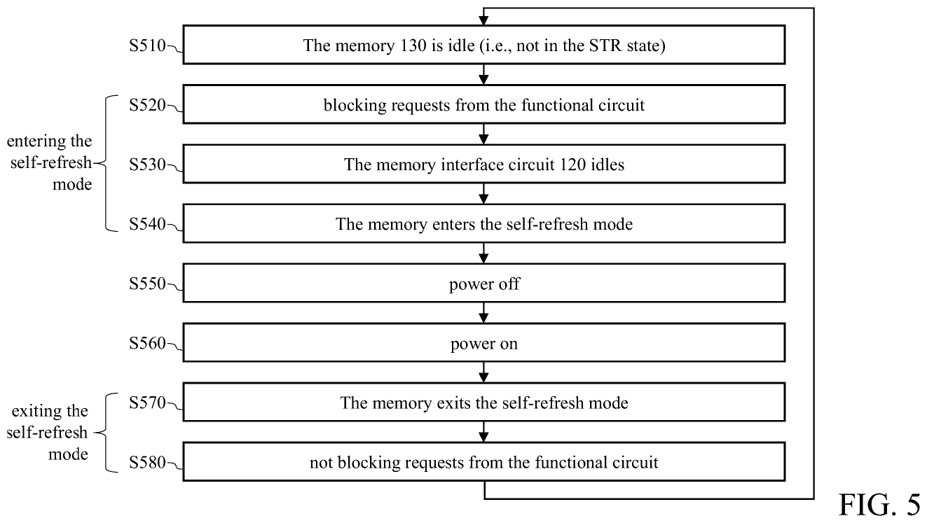

Reference is made to FIG. 5, which is a flowchart of the memory entering and exiting the self-refresh mode SR according to an embodiment of the present invention. FIG. 5 includes the following steps.

Step S510: The memory 130 is idle (i.e., not in the STR state). For example, this step can correspond to the idle mode IDL1 or the idle mode IDL2 in FIG. 3.

Step S520: The memory interface circuit 120 blocks requests from the functional circuit, so that the memory 130 does not receive requests from the functional circuit when operating in the self-refresh mode SR later. For example (referring to FIG. 3), the memory 130 does not receive the request RQ6 in the STR state in the time slot TS2. In some embodiments, the request RQ6 is temporarily stored in the command storage circuit 122.

Step S530: The memory interface circuit 120 idles to save power.

Step S540: The memory 130 enters the self-refresh mode SR. This step can correspond to the time point t7 or the time point t11 in FIG. 3.

Step S550: The power of the memory 130 is turned off.

Step S560: The power of the memory 130 is turned on.

Step S570: The memory 130 exits the self-refresh mode SR.

Step S580: The memory interface circuit 120 does not block requests from the functional circuit, so that the memory 130 can process the requests. For example, this step can correspond to the time point t3, the time point t8, or the time point t13 in FIG. 3.

From FIGS. 3 to 5, it is evident that, in one embodiment of the present invention, the memory interface circuit 120 automatically controls the memory 130 to periodically enter the self-refresh mode SR (steps S520 to S540, corresponding to the STR states in FIG. 3) and exit the self-refresh mode SR (steps S570 to S580, corresponding to either the idle mode IDL1 or the idle mode IDL2 in FIG. 3) according to the count values (CV1 and CV2).

In some embodiments, an application or firmware on the electronic device 100 (executed by the computing circuit 110) can switch the state machine 124 of the memory interface circuit 120 (i.e., from the self-refresh mode SR to the idle mode IDL, or from the idle mode IDL to the self-refresh mode SR) by simply setting a register, thereby significantly reducing the management burden of the electronic device 100 on the memory 130. For the embodiment of FIG. 3, the computing circuit 110 can enable the automatic STR state of the memory interface circuit 120. In the automatic STR state, the memory interface circuit 120 only needs to periodically set a register to make the memory 130 periodically enter and exit the self-refresh mode SR.

In summary, because the memory 130, when operating in the STR state, is controlled by the memory interface circuit 120 instead of being controlled by software, the system of the electronic device 100 does not need to undergo a media switch when entering and exiting the STR state. This not only significantly simplifies the process but also greatly enhances the response speed of the electronic device 100. In addition, it is possible to adjust the proportion of the STR state in a time slot by adjusting the first preset value (D1) and/or the second preset value (D2). The larger the ratio of the first preset value to the second preset value (D1/D2), the greater the proportion of the STR state in a time slot (i.e., the electronic device 100 is more power-efficient).

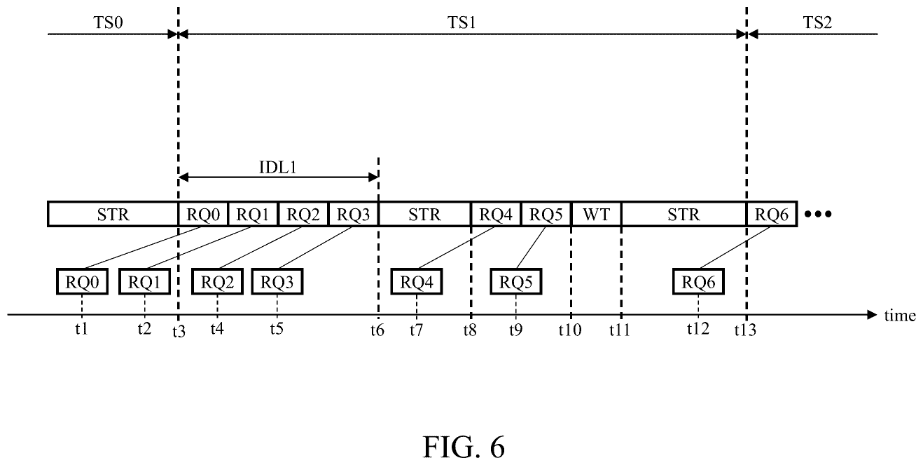

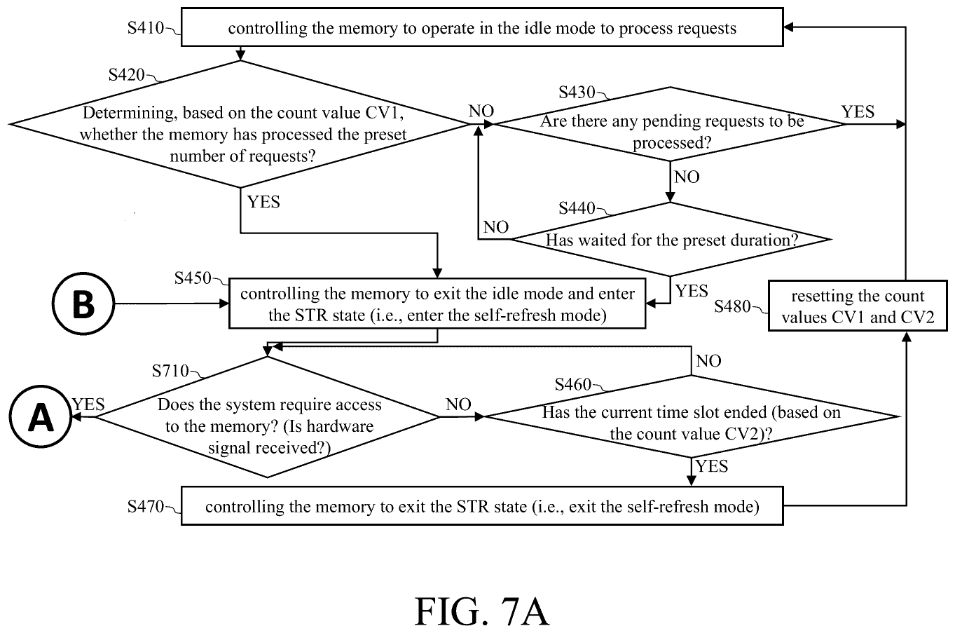

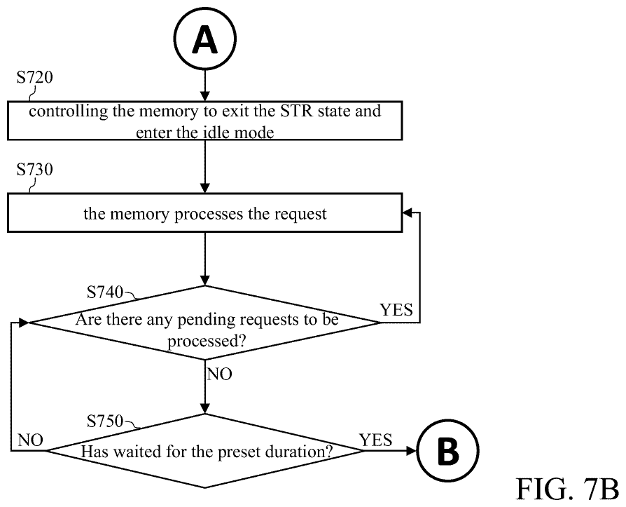

Reference is made to FIG. 6 and FIGS. 7A to 7B. FIG. 6 is the schematic diagram of the memory state according to another embodiment of the present invention. FIGS. 7A to 7B, which correspond to FIG. 6, are flowcharts of the memory control method according to another embodiment of the present invention. The embodiments of FIG. 6 and FIGS. 7A to 7B are partially similar to the embodiments of FIGS. 3 to 4. However, in the embodiments of FIG. 6 and FIGS. 7A to 7B, the memory interface circuit 120 interrupts the STR state of the memory 130 during the time slot TS1 (more specifically, at the time point t8) to handle the high-priority requests RQ4 and RQ5. Then, after waiting for the preset duration WT (more specifically, at the time point t11), the memory interface circuit 120 controls the memory 130 to enter the STR state again. The detailed process is shown in FIGS. 7A to 7B. The steps S410 to S480 in FIG. 7A are the same as those in FIG. 4, so further elaboration is omitted for brevity. FIGS. 7A to 7B further include steps S710 to S750.

Step S710: After the memory 130 enters the STR state (Step S450), the memory interface circuit 120 determines whether the system (i.e., the software or hardware of the electronic device 100) requires access to the memory 130. If YES, then the flow proceeds to step S720; otherwise, the flow proceeds to step S460. Reference is made to FIG. 6, this step can correspond to the time point t7. At the time point t7, the system has a demand for emergency access to the memory 130 (the request RQ4, which is, for example, issued by a time-sensitive functional circuit). In some embodiments, when the system requires emergency access to the memory 130, the computing circuit 110 notifies the memory interface circuit 120 through a hardware signal RG (e.g., by writing to a register). The memory interface circuit 120 can perform the determination of step S710 based on the hardware signal RG.

Before the end of the current time slot (i.e., when the result of step S460 is NO), the memory interface circuit 120 continues to perform step S710.

Step S720: The memory interface circuit 120 controls the memory 130 to exit the STR state (i.e., exit the self-refresh mode SR) and enter the idle mode IDL. This step can correspond to the time point t8 in FIG. 6.

Step S730: The memory 130 processes the request (for example, the request RQ4).

Step S740: After the memory 130 has processed the current request (e.g., the request RQ4), the memory interface circuit 120 determines whether there are any pending requests to be processed. If YES, then the memory 130 subsequently processes the request (step S730); otherwise, the flow proceeds to step S750. In the example of FIG. 6, since the memory 130 still has the request RQ5 to be processed (generated at the time point t9) after processing the request RQ4, the memory 130 then processes the request RQ5, and the memory interface circuit 120 subsequently determines in the next step S740 that there are no pending requests to be processed (the result of step S740 is NO, corresponding to the time point t10 in FIG. 6).

Step S750: The memory interface circuit 120 determines whether it has waited for the preset duration WT. Step S750 is similar to Step S440, and reference can be made to the discussion of Step S440. When the waiting time is greater than or equal to the preset duration WT (step S750 is YES), the memory interface circuit 120 then controls the memory 130 to enter the STR state (step S450, corresponding to the time point t11 in FIG. 6).

In summary, in the embodiments of FIG. 6 and FIGS. 7A to 7B, the memory interface circuit 120 not only periodically controls the memory 130 to enter the STR state to save power but also has the ability to handle important packets (e.g., the requests RQ4 and RQ5), thereby enhancing the stability and operational flexibility of the electronic device 100. Furthermore, because the entry and exit of the memory 130 into and out of the STR state do not involve procedures such as switching the media on which the system is operating, suspending the functional circuit, suspending the system, resuming the system, and resuming the functional circuit, in the present invention, the dormancy and wake-up of the memory 130 can be achieved without disconnecting from the system kernel (i.e., without needing to switch to user space), significantly improving the response speed of the memory 130 in the STR state. Therefore, even if the memory 130 is in a dormant state, when the computing circuit 110 and the functional circuit of the electronic device 100 need to access the memory 130, the memory 130 can respond quickly.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A memory interface circuit applied to an electronic device comprising a computing circuit and a memory, the memory interface circuit being coupled to the computing circuit and the memory and comprising:
a command storage circuit configured to store at least one command;
a state machine coupled to the command storage circuit and configured to manage a current mode of the memory; and
a memory control circuit coupled to the state machine and configured to switch the current mode of the memory;
wherein the memory control circuit controls the memory to periodically operate in a first mode and a second mode, and the memory does not process the at least one command in the first mode.

2. The memory interface circuit of claim 1, wherein the memory control circuit comprises:
a counter configured to generate a count value; and
a control unit coupled to the counter and configured to control, according to the count value, the memory to exit the first mode.

3. The memory interface circuit of claim 2, wherein the control unit further controls, according to the count value, the memory to operate in a time slot, and when the count value equals a preset value, the time slot ends, and the control unit controls the memory to exit the first mode.

4. The memory interface circuit of claim 1, wherein the memory operates in the first mode or the second mode in a time slot, the memory processes the at least one command in the second mode, and the memory control circuit comprises:
a counter configured to generate a count value based on a number of the at least one command processed by the memory in the second mode; and
a control unit coupled to the counter and configured to control, according to the count value, the memory to exit the second mode and enter the first mode in the time slot.

5. The memory interface circuit of claim 4, wherein when the count value equals a preset value, the control unit controls the memory to exit the second mode and enter the first mode.

6. The memory interface circuit of claim 1, wherein the memory operates in the first mode or the second mode in a time slot, the memory processes the at least one command in the second mode, and the memory control circuit further waits for a preset duration in the second mode of the time slot before controlling the memory to exit the second mode and enter the first mode.

7. The memory interface circuit of claim 6, wherein within the preset duration, the memory does not process any commands.

8. The memory interface circuit of claim 6, wherein the time slot is a first time slot, the memory further operates in a second time slot, and a first duration of the first mode of the first time slot is greater than or equal to a second duration of the first mode of the second time slot.

9. The memory interface circuit of claim 6, wherein the time slot is a first time slot, the memory further operates in a second time slot, and a first duration of the second mode of the first time slot is less than or equal to a second duration of the second mode of the second time slot.

10. The memory interface circuit of claim 1, wherein the memory operates in the first mode or the second mode in a time slot, the memory processes the at least one command in the second mode, and in the first mode of the time slot, the memory control circuit further controls, according to a hardware signal, the memory to exit the first mode and enter the second mode to process the at least one command.

11. A memory control method applied to a memory interface circuit, the memory interface circuit storing at least one command and comprising a first counter and a second counter, the first counter and the second counter respectively generating a first count value and a second count value, the method comprising:
controlling, according to the first count value, a memory to exit a first mode and enter a second mode; and
controlling, according to the second count value, the memory to exit the second mode and enter the first mode;
wherein in the second mode, the memory does not process the at least one command.

12. The method of claim 11 further comprising:
controlling, according to the second count value, the memory to operate in a time slot; and
when the second count value equals a preset value, the time slot ends and controlling the memory to exit the second mode.

13. The method of claim 11 further comprising:
periodically resetting the second counter.

14. The method of claim 11, wherein the memory processes the at least one command in the first mode, and the first count value is a number of the at least one command processed by the memory in the first mode.

15. The method of claim 14 further comprising:
controlling the memory to exit the first mode and enter the second mode when the first count value equals a preset value.

16. The method of claim 11, wherein the memory operates in the first mode or the second mode during a time slot, the memory processes the at least one command in the first mode, and the method further comprises:
controlling the memory to exit the first mode and enter the second mode after waiting for a preset duration in the first mode of the time slot.

17. The method of claim 16, wherein within the preset duration, the memory does not process any commands.

18. The method of claim 16, wherein the time slot is a first time slot, the memory further operates in a second time slot, and a first duration of the second mode of the first time slot is greater than or equal to a second duration of the second mode of the second time slot.

19. The method of claim 16, wherein the time slot is a first time slot, the memory further operates in a second time slot, and a first duration of the first mode of the first time slot is less than or equal to a second duration of the first mode of the second time slot.

20. The method of claim 11, wherein the memory operates in the first mode or the second mode during a time slot, the memory processes the at least one command in the first mode, and the method further comprises:
in the second mode of the time slot, controlling, according to a hardware signal, the memory to exit the second mode and enter the first mode to process the at least one command.
